(19) United States
(12) Patent Application Publication
(10) Pub. No.: US 2009/0233102 A1
(43) Pub. Date: Sep. 17, 2009

(54) PRESSURE SENSITIVE ADHESIVE FOR OPTICAL FILM, PRESSURE SENSITIVE ADHESIVE LAYER FOR OPTICAL FILM, METHOD FOR MANUFACTURING THE SAME, PRESSURE SENSITIVE ADHESION TYPE OPTICAL FILM, AND IMAGE DISPLAY

(75) Inventors: Yuusuke Toyama, Osaka (JP); Masayuki Satake, Osaka (JP); Akiko Ogasawara, Osaka (JP); Yutaka Moroishi, Osaka (JP); Fumiko Nakano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/720,688

(22) PCT Filed: Nov. 17, 2005
(86) PCT No.: PCT/JP05/21134

§ 371 Date: Jun. 1, 2007

(30) Foreign Application Priority Data
Dec. 2, 2004 (JP) 2004-349584

(51) Int. Cl. B32B 27/40; C08K 3/18; B05D 3/00

(52) U.S. Cl. 428/423.1; 524/401; 427/331

(57) ABSTRACT

The invention relates to a pressure-sensitive adhesive for an optical film, comprising 0.02 to 2 parts by weight of a peroxide (B) and 0.01 to 5 parts by weight of an isocyanate-based compound (C) contained in 100 parts by weight of a (meth)acrylic polymer (A) consisting primarily of an alkyl(meth)acrylate and not containing a functional group reactive with an isocyanate group. By using the invented pressure-sensitive adhesive for an optical film, there can be obtained a pressure sensitive adhesion type optical film that can suppress warping and light leakage caused by a stress accompanying a dimensional change of members such as an optical film, has high durability, is excellent in handling ability in the manufacturing process and is excellent in quality.

### TECHNICAL FIELD

The invention relates to a pressure sensitive adhesive for an optical film. The invention further relates to a manufacturing method for a pressure sensitive adhesive layer for an optical film using the pressure sensitive adhesive for an optical film and a pressure sensitive adhesive for an optical film obtained by the manufacturing method. The invention still further relates to a pressure sensitive adhesion type optical film comprising the pressure sensitive adhesive layer for an optical film laminated on at least one surface of an optical film. The invention still further relates to an image display such as a liquid crystal display, an organic electro-luminescent (EL) display, plasma display panel (PDP) and the like using the pressure sensitive adhesion type optical film. Examples of the optical film include a polarizing plate, a retardation plate, an optical compensation film, a brightness enhancement film and a laminate thereof.

### BACKGROUND ART

A liquid crystal display indispensably requires polarizing elements disposed on both sides of a liquid crystal cell because of an image forming method adopted therein and generally polarizing plates are adhered. Besides, on a liquid crystal panel, various kinds of optical elements have been used in addition to a polarizing plate in order to improve a display quality of a display. For example, there have been used a retardation plate for coloration prevention, a viewing angle increasing film for improving a viewing angle of a liquid crystal display and a brightness enhancement film for raising a contrast of a display. The films each are collectively referred to an optical film.

A pressure sensitive adhesive is usually employed in adhering then optical film described above to a liquid crystal cell. An optical film and a liquid crystal cell or optical films are usually adhered to each other using a pressure sensitive adhesive therebetween in order to reduce a light loss. In such cases, a pressure sensitive adhesion type optical film in which a pressure sensitive adhesive is provided in advance on one surface of an optical film as a pressure sensitive adhesive layer is generally used because of a merit such as that no necessity arises for a drying step of fixing the optical film.

The optical film described above is easy to contract or expand in conditions such as heating or humidifying; therefore, after the optical film is adhered to a liquid crystal panel, film lifting or peeling off occurs with ease. In applications of vehicle installation such as car navigation and a large size television, for which a high durability is required, a necessity arises for a pressure sensitive adhesive with difficulty for causing film lifting or peeling off. Moreover, in some case, inconvenient phenomena occur that a liquid crystal cell is warped due to contraction or expansion of an optical film, as described above, and light leaks in the peripheral area of a liquid crystal panel generated by a residual stress in the optical film proper. In order to eliminate the phenomena, a proposal has been offered on a pressure sensitive adhesive composition containing a component of a plasticizer or an oligomer as a pressure sensitive adhesive for an optical film (JP-A Nos. 9-84593 and 10-279907).

As the pressure sensitive adhesive used in the pressure sensitive adhesion type optical film described above, an acrylic pressure sensitive adhesive comprising an acrylic polymer as a base polymer is frequently used because of its excellent adherence, transparency etc. A method of crosslinking the acrylic pressure sensitive adhesive often makes use of an isocyanate-based crosslinking agent and mainly utilizes bonding to functional monomers copolymerized with the acrylic polymer. For solving the warping of a panel and light leakiness, on the other hand, a stress accompanying a dimensional change of the substrate should be sufficiently relaxed, so generally the amount of a crosslinking agent used in the acrylic pressure sensitive adhesive is preferably made smaller to reduce the degree of crosslinking, and further the molecular weight is reduced, and a pressure sensitive adhesive component of high Tg to be copolymerized is used in a reduced amount or is not used, thus imposing a significant limitation on design (JP-A No. 2002-241708).

On the other hand, the pressure sensitive adhesion type optical film described above is punched or slit into pieces with a predetermined size, in which working possibilities arise that a pressure sensitive adhesive is taken away by a cutting blade or a pressure sensitive adhesive is swelled out from a cutting surface. An unfavorable possibility is expected that a pressure sensitive adhesive is taken away from or contaminates a punched optical film during visual inspection or transport of the punched optical film. It is an important issue to improve handling ability in an aspect of fabrication process of an optical film in addition to prevention of the peeling off and warping and light leakage, whereas improvement on the issue cannot be expected with use of a pressure sensitive adhesive composition containing a component of a plasticizer or an oligomer.

Patent No.: Japanese Patent Application Laid-Open No. 9-84593

Patent No. 2: Japanese Patent Application Laid-Open No. 10-279907

Patent No. 3: Japanese Patent Application Laid-Open No. 2002-241708

### DISCLOSURE OF THE INVENTION

### Problems to be Solved by the Invention

It is an object of the invention to provide a pressure sensitive adhesive for an optical film, which is capable of giving a pressure sensitive adhesion type optical film that can suppress warping and light leakage caused by a stress accompanying a dimensional change of members such as an optical film, has high durability, is excellent in handling ability in respect of the manufacturing process and is excellent in quality. It is another object of the invention to provide a pressure sensitive adhesive layer for an optical film using the pressure sensitive adhesive for an optical film and a method for manufacturing the same.

It is still another object of the invention to provide a pressure sensitive adhesion type optical film in which the pressure sensitive adhesive layer for an optical film is laminated on at least one surface of an optical film. It is still another object of the invention to provide an image display using the pressure sensitive adhesion type optical film.

### Means for Solving the Problems

The inventors have been conducted serious studies in order to solve the problems and as a result, they found the pressure sensitive adhesive for an optical film described below, which has led to completion of the invention.

That is, the invention relates to a pressure sensitive adhesion type optical film comprising an acrylic pressure sensitive adhesive layer laminated on at least one surface of an optical film,

wherein the pressure sensitive adhesive layer is formed from a pressure sensitive adhesive comprising 0.02 to 2 parts by weight of a peroxide (B) and 0.01 to 5 parts by weight of an isocyanate-based compound (C) contained in 100 parts by weight of a (meth)acrylic polymer (A) consisting primarily of an alkyl(meth)acrylate and not containing a functional group reactive with an isocyanate group.

In forming the pressure sensitive adhesive layer, the pressure sensitive adhesion type optical film of the invention uses a pressure sensitive adhesive composition comprising the predetermined amounts of the peroxide (B) and the isocyanate-based compound (C) incorporated into the (meth)acrylic polymer (A) not having a functional group reacting with an isocyanate group. The crosslinkage of the (meth)acrylic polymer (A) is thereby regulated by the thermal decomposition/crosslinking reaction with the peroxide (B) only, and the isocyanate-based compound (C) is not allowed to participate in the crosslinkage of the (meth)acrylic polymer (A). As a result, sufficient strain release property can be maintained, excellent durability can be kept, and excellent handling ability can be maintained in the manufacturing process.

As described above, the (meth)acrylic polymer (A) does not have a functional group reacting with an isocyanate group, and thus its crosslinking is effected with the peroxide (B) only. As a result, strain release property can be maintained. On the other hand, the isocyanate-based compound (C) is not allowed to act on crosslinkage of the (meth)acrylic polymer (A) but allowed to contribute only to improvement of adherence to the optical film. In the invention, therefore, the proportion of the peroxide (B) and isocyanate-based compound (C) contained in the pressure sensitive adhesive is defined in the range mentioned above.

When the adherence between the optical film and the pressure sensitive adhesive layer is insufficient, there may arise inconveniences such as residual adhesive upon panel reworking, reduction in workability etc. However, the pressure sensitive adhesion type optical film of the invention is excellent in handling ability and is thus almost free of problems with respect to workability. In the method of crosslinking with the pressure sensitive adhesive of the invention, a majority of the materials are crosslinked in an initial stage. As described above, the pressure sensitive adhesion type optical film of the invention is excellent in handling ability and thus can be immediately subjected to processing treatment. When the adherence to the optical film is lowered, the inferior adherence causes adhesive drawing, adhesive protrusion and adhesive contamination upon processing treatment such as punching, thus adversely increasing defects in another production step and defects such as adhesive deficiency by contacting around the side of the polarizing plate, thus making its applicability impossible. However, the isocyanate-based compound (C) used in the pressure sensitive adhesive of the invention acts only for adherence between the optical film and the pressure sensitive adhesive layer, thus satisfying adherence too.

In the pressure sensitive adhesion type optical film, it is preferable that adherence between an optical film and a pressure sensitive adhesive layer is 10 N/25 mm or more in a 90° C. peel test. With the adhering strength of 10 N/25 mm or more, it can be determined that the adherence is satisfied. The above adhering strength is also preferable for reducing a residual adhesive at the time of reworking. The adhering strength is preferably 12 N/25 mm or more, more preferably 15 N/25 mm or more.

The invention also relates to a pressure sensitive adhesive for an optical film, which is used in the pressure sensitive adhesive layer of the pressure sensitive adhesion type optical film and comprises 0.02 to 2 parts by weight of a peroxide (B) and 0.01 to 5 parts by weight of an isocyanate-based compound (C) contained in 100 parts by weight of a (meth)acrylic polymer (A) consisting primarily of an alkyl(meth)acrylate and not containing a functional group reactive with an isocyanate group.

Furthermore, the invention is also directed to an image display using at least one sheet of the pressure sensitive adhesion type optical film. In the invention, these pressure sensitive adhesion type optical films may be used alone, or two or more kinds may be used in combination, according to aspects of use of image displays such as liquid crystal displays.

### BEST MODE FOR CARRYING OUT THE INVENTION

The pressure sensitive adhesion type optical film of the invention is obtained by laminating an acrylic pressure sensitive adhesive on at least one surface of an optical film. The pressure sensitive adhesive layer may be provided on either one surface or both surfaces of an optical film.

The pressure sensitive layer of the pressure sensitive adhesion type optical film of the invention is formed from an acrylic pressure sensitive adhesive. The acrylic pressure sensitive adhesive contains an alkyl(meth)acrylate-based (meth)acrylic polymer (A) as a base polymer. The (meth)acrylic polymer (A) does not have a functional group reacting with an isocyanate group. The terms “(meth)acrylate” refers to acrylate and/or methacrylate, and the term “(meth)” in the invention has the same meaning.

An alkyl group of an alkyl(meth)acrylate (al) constituting the main skeleton of the (meth)acrylic polymer (A) has about 1 to 18 carbon atoms, preferably about 1 to 9 carbon atoms, and examples of alkyl(meth)acrylates include methyl(meth)acrylate, ethyl (meth)acrylate, propyl(meth)acrylate, n-butyl(meth)acrylate, iso-butyl(meth)acrylate, 2-ethylhexyl(meth)acrylate, n-octyl (meth)acrylate, iso-octyl(meth)acrylate, lauryl(meth)acrylate, stearyl (meth)acrylate, cyclohexyl(meth)acrylate etc. They can be used either alone or in combination. The alkyl group thereof preferably has 3 to 9 carbon atoms on average.

The (meth)acrylic polymer (A) can contain other copolymerizable components in addition to the alkyl(meth)acrylate. Examples of the other copolymerizable components include components not having a functional group reacting with an isocyanate group, for example benzyl(meth)acrylate, methoxyethyl (meth)acrylate, ethoxymethyl(meth)acrylate, phenoxyethyl (meth)acrylate, (meth)acrylamide, vinyl acetate, and (meth)acrylonitrile. The amount of these components copolymerized is preferably 100 parts by weight or less, more preferably 50 parts by weight or less, relative to 100 parts by weight of the alkyl (meth)acrylate (al).

The average molecular weight of the (meth)acrylic polymer is particularly not limited, but the weight average molecular weight of about 500,000 to 2,500,000 is preferable. The (meth)acrylic polymer may be produced by a variety of known methods, for example, by a method appropriately selected from radical polymerization methods including a bulk polymerization method, a solution polymerization method and a suspension polymerization method. A variety of known radical polymerization initiators such as azo initiators and peroxide initiators may be used. The reaction is generally performed at a temperature of about 50° C. to about 80° C. for a time period of 1 to 8 hours. Among the above methods, the solution polymerization method is particularly preferred, and ethyl acetate, toluene or the like is generally used as a solvent for the (meth)acrylic polymer. The concentration of the solution is generally from about 20 to about 80% by weight.

The acrylic pressure sensitive adhesive of the invention comprises 0.02 to 2 parts by weight of a peroxide (B) and 0.01 to 5 parts by weight of an isocyanate-based compound (C) contained in 100 parts by weight of (meth)acrylic polymer (A).

The peroxide (B) can be any peroxide without placing specific limitation thereon as far as it can generate a radical by heating thereby achieving the crosslinking of (meth)acrylic polymer (A). In consideration of productivity, its one minute half-life temperature is preferably in the range of about 70 to 170° C., more preferably in the range of about 90 to 150° C. If the one minute half-life temperature is too low, a crosslinking reaction occurs in storage prior to coating of a pressure sensitive adhesive, thereby raising the viscosity of a coating material to make coating infeasible in some case. On the other hand, if the one minute half-life temperature is too high, a temperature in a cross-linking reaction is raised to thereby unpreferably cause other side effects, to disable a target characteristic to be achieved due to insufficiency of decomposition, or to cause a cross-linking reaction to progress over time thereafter in the presence of the residual peroxide.

Examples of such peroxides (B) include di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxyisobutylate, dibenzoyl peroxide and the like. Among them, preferably used are di(4-t-butylcyclohexyl) peroxydicarbonate, dilauroyl peroxide and dibenzoyl peroxide, which are especially excellent in crosslinking reaction efficiency.

The amount of peroxide (B) used is in the range of from 0.02 to 2 parts by weight, preferably in the range of from 0.05 to 1 part by weight, relative to 100 parts by weight of (meth) acrylic polymer (A). When the amount of peroxide (B) used is less than 0.02 part by weight, it is unpreferable in regard to durability since a crosslinking reaction is insufficient. On the other hand, the amount of peroxide (B) used exceeds 2 parts by weight, it is unpreferable since crosslinking occurs in excess, thereby degrading adherence.

The isocyanate-based compound (C) contains an isocyanate compound. Examples of the isocyanate compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, hydrogenated diphenylmethane diisocyanate, and adduct type isocyanate compounds obtained by adding the isocyanate monomer to trimethylolpropane or the like; and urethane prepolymer type isocyanates obtained by addition reaction of an isocyanurate compound, a burette type compound, in addition thereto a known polyether polyol, a known polyester polyol, an acryl polyol, a polybutadiene polyol, a polyisoprene polyol and the like. Preferable among the isocyanate-based compounds (C) is an adduct type isocyanate compound such as xylylene diisocyanate in terms of improvement on adherence to an optical film.

The amount of the isocyanate-based compound (C) used is in the range of from 0.01 to 5 parts by weight, preferably 0.02 to 3 parts by weight, relative to 100 parts by weight of (meth)acrylic polymer (A). When the amount of the isocyanate-based compound (C) used is less than 0.01 part by weight, it is unpreferable in regard to adherence to an optical film. On the other hand, the amount of the isocyanate-based compound (C) used exceeds 5 parts by weight, adherence is improved according to the amount in excess, but the pseudo-crosslinkage of the isocyanate-based compound (C) itself is caused to deteriorate the intended viscosity characteristic in some cases.

If necessary, the acrylic pressure sensitive adhesive of the invention may conveniently contain various types of additives such as tackifiers, plasticizers, fillers such as glass fibers, glass beads, metal power, or any other inorganic powder, pigments, colorants, antioxidants, ultraviolet absorbers, and silane-coupling agents, without departing from the object of the invention. The pressure-sensitive adhesive layer may also contain fine particles so as to have light diffusion properties.

Among the additives described above, the silane coupling agent is preferably incorporated. Examples of the silane coupling agent include silicon compounds having an epoxy structure such as 3-glycidoxypropyltrimethoxysilane, 3-glycidoxypropylmethyldimethoxysilane and 2-(3,4-epoxycyclohexyl)ethyltrimethoxysilane; amino group-containing silicon compounds such as 3-aminopropyltrimethoxysilane, N-(2-aminoethyl)-3-aminopropyltrimethoxysilane and N-(2-aminoethyl)-3-aminopropylmethyldimethoxysilane; and 3-chroropropyltrimethoxysilane. The silane coupling agent can impart durability and an effect of suppressing peeling off especially in humidified environment. The amount of the silane coupling agent used is 1 part by weight or less, preferably in the range of from 0.01 to 1 part by weight, more preferably in the range of from 0.02 to 0.6 part by weight, relative to 100 parts by weight of (meth)acrylic polymer (A). When the amount of the silane coupling agent used is larger, an adhering strength to a liquid crystal cell is excessively large, which creates a case where an influence is given on reworkability.

Adhesiveness can be improved by arranging an anchor coat layer between the pressure sensitive adhesive layer of the pressure sensitive adhesion type optical film of the invention and the optical film. The material forming the anchor coat layer is not particularly limited, but the material is preferably a material showing good adherence to both the pressure sensitive adhesive layer and the optical film and forming a film excellent in cohesive force. Examples of materials showing such properties include various kinds of polymers, a sol of a metal oxide, silica sol and the like. Among them, polymers are especially preferably used.

Examples of the polymers include a polyurethane-based resin, a polyester-based resin and polymers each containing an amino group in a molecule. States in use of the polymers may be any of a solvent-soluble type, a water-dispersion type and a water-soluble type. Examples thereof include a water-soluble polyurethane, a water-soluble polyester, a water-soluble polyamide and water-dispersion type resins (an ethylene-vinyl acetate-based emulsion, a (meth)acrylic emulsion and the like). Besides, water-dispersion types include emulsions of various kinds of resins such as polyurethane, polyester, polyamide and the like obtained by using an emulsifying agent, emulsions of the resins obtained from self-emulsifiable resins obtained by introducing an anion group, a cation group or a nonion group each of a water-dispersible hydrophillic group into the resins and the like. Besides, an ionic polymer complex can be used.

Such polymers are preferably polymers each containing a functional group having a reactivity with an isocyanate-based compound (C) in a pressure sensitive adhesive. The polymers are preferably polymers each containing an amino group in a molecule. A polymer having a primary amino group at the terminals is especially preferably used and confirmed to strongly adhere by reaction with the isocyanate-based compound (C).

Examples of polymers containing an amino group in a molecule include polyethyleneimine, polyallylamine, polyvinylamine, polyvinylpyridine, polyvinylpyrrolidine, a polymer of an amino group-containing monomer such as dimethylaminoethyl acrylate. Among them, polyethyleneimine is preferable.

The polyethyleneimine is not particularly limited, and various kinds of polyethyleneimines can be used. The weight-average molecular weight of polyethyleneimine is not particularly limited, whereas the weight-average molecular weight is usually in the range of about 100 to 1,000,000. Examples of polyethyleneimine as commercial products are named Epomin SP series (SP-003, SP-006, SP-012, SP-018, SP-103, SP-110, SP-200, and the like) and Epomin P-1000 and the like manufactured by Nippon Shokubai Co., Ltd. Among them, Epomin P-1000 is preferable.

Any of polyethyleneimines may be used as far as it has a polyethylene structure and examples thereof include an ethyleneimine adduct to a polyacrylic acid ester and/or a polyethyleneimine adduct. A polyacrylic acid ester is obtained by emulsion polymerization according to an ordinary method from an alkyl(meth)acrylate constituting a base polymer of the acrylic pressure sensitive adhesive (acrylic polymer) exemplified above, with a monomer copolymerizable therewith. The copolymerizable monomer used is a monomer having a functional group such as a carboxyl group to react the copolymerizable monomer with ethyleneimine. The proportion of the monomer having a functional group such as carboxyl group is adjusted properly depending on the proportion of ethyleneimine to be reacted therewith. The copolymerizable monomer used is preferably a styrene monomer, as described above. The copolymerizable monomer can also be an grafted adduct of polyethyleneimine by reacting a separately synthesized polyethyleneimine with a carboxyl group or the like in an acrylic acid ester. For example, Polyment NK-380 manufactured by Nippon Shokubai Co., Ltd. can be mentioned as a commercial product.

An ethyleneimine adduct and/or a polyethyleneimine adduct of an acrylic polymer emulsion can also be used. An example of a commercial product is Polyment SK-1000 manufactured by Nippon Shokubai Co., Ltd.

Polyallylamine includes, but is not limited to, allyamine-based compounds such as diallylamine hydrochloride-sulfur dioxide copolymer, diallylmethylamine hydrochloride copolymer, polyallylamine hydrochloride, and polyallylamine, condensates of polyalkylene polyamine and dicarboxylic acid such as diethylene triamine and an epihalohydrin adduct of the condensate, polyvinylamine and the like. Polyallylamine is preferable since it is soluble in water/alcohol. The weight-average molecular weight of polyallylamine is not particularly limited, and is preferably in the range of about 10,000 to 100,000.

In formation of an anchor coat layer, the strength of the anchor coat layer can be raised by mixing a polymer containing an amino group with a compound reacting with the polymer containing an amino group and then crosslinking them. Examples of the compound reacting with a polymer containing an amino group can include an epoxy compound or the like.

The optical film for use in the pressure sensitive adhesion type optical film of the invention may be any type of film that has been used to form image displays such as liquid crystal displays. Examples of the optical film include a polarizing plate. A polarizing plate comprising a transparent protective film provided on one side or both sides of a polarizer is generally used.

The polarizer is particularly not limited, and various kinds of polarizers can be used. As the polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. Among these compounds, a polarizer consisting of a polyvinyl alcohol type film and a dichromatic material such as iodine is preferable. The thickness of the polarizer is not particularly limited, but is generally about 5 to 80 μm.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If necessary, the film may also be dipped in an aqueous solutions of boric acid and potassium iodide, optionally containing zinc sulfate, zinc chloride, etc. Furthermore, before dyeing, the polyvinyl alcohol type film may be dipped in water and rinsed with water if needed. By rinsing polyvinyl alcohol type film with water, soils and blocking inhibitors on the polyvinyl alcohol type film surface can be washed off, and an effect of preventing un-uniformity, such as unevenness of dyeing, can also be brought about by swelling the polyvinyl alcohol type film. Stretching may be applied after dyed with iodine or may be applied concurrently, or conversely dyeing with iodine may be applied after stretching. Stretching is applicable in aqueous solutions, such as boric acid and potassium iodide, and in water bath.

The material forming the transparent protective film prepared on one side or both sides of the above-mentioned polarizer is preferably a material excellent in transparency, mechanical strength, heat stability, moisture-shielding property and isotropy. For example, polyester type polymers such as polyethylene terephthalate and polyethylene naphthalate; cellulose type polymers such as diacetyl cellulose and triacetyl cellulose; acrylic polymers such as polymethyl methacrylate; styrene type polymers such as polystyrene and acrylonitrile-styrene copolymer (AS resin); and polycarbonate type polymer may be mentioned. Additional examples of the polymer forming a protective film include polyolefin type polymers such as polyethylene, polypropylene, polyolefin that has cyclo-type or norbornene structure, and ethylene-propylene copolymer; vinyl chloride type polymer; amide type polymers such as nylon and aromatic polyamide; imide type polymers; sulfone type polymers; polyether sulfone type polymers; polyether-ether ketone type polymers; polyphenylene sulfide type polymers; vinyl alcohol type polymer; vinylidene chloride type polymers; vinyl butyral type polymers; allylate type polymers; polyoxymethylene type polymers; epoxy type polymers; and blend polymers of the above-mentioned polymers. The transparent protective film can be formed as a cured layer made of heat curing type or ultraviolet ray curing type resins such as acryl based, urethane based, acryl urethane based, epoxy based, and silicone based.

Moreover, as is described in Japanese Patent Laid-Open Publication No. 2001-343529 (WO 01/37007), polymer films, for example, resin compositions including (A) thermoplastic resins having substituted and/or unsubstituted imido group in side chain, and (B) thermoplastic resins having substituted and/or unsubstituted phenyl and nitrile group in side chain may be mentioned. A specific example includes a film made of a resin composition containing alternating copolymer comprising isobutylene and N-methyl maleimide, and acrylonitrile-styrene copolymer. A film comprising a mixture extruded article of resin compositions etc. may be used.

The thickness of the protection film can be determined arbitrarily, but is generally about 1 to 500 μm, especially 5 to 200 μm, from the viewpoint of strength, work handling and thin layer.

The protective film is preferably as colorless as possible. It is thus preferable to use a protective film having a retardation of −90 nm to +75 nm in the thickness direction of the film, the retardation (Rth) being represented by the equation Rth=(nx−nz)d wherein nx is a refractive index in the retardation phase axial direction in the plane of the film, nz is a refractive index in the thickness direction of the film, and d is the thickness of the film. When such protective film having a thickness-direction retardation value (Rth) of −90 nm to +75 nm is used, the coloration (optical coloration) of the polarizing plate can be almost avoided, which could otherwise be caused by any other protective film. The thickness-direction retardation (Rth) is more preferably from −80 nm to +60 nm, particularly preferably from −70 nm to +45 nm.

As the protective film, if polarization property and durability are taken into consideration, cellulose based polymer such as triacetyl cellulose is preferable, and especially triacetyl cellulose film is suitable. In addition, when protective films are provided on both sides of the polarizer, transparent protective films comprising the same polymer material may be used on both of a front side and a back side, and protective films comprising different polymer materials etc. may be used. The polarizer and the protective film are attached firmly to each other, usually via an aqueous adhesive or the like. The aqueous adhesive can be exemplified by isocyanate based adhesives, polyvinyl alcohol based adhesives, gelatin based adhesives, vinyl latex based adhesives, aqueous polyurethane, aqueous polyesters, etc.

The side of the transparent protective film to which the polarizer is not attached may be treated with a hard coat layer or may be subjected to various treatments such as antireflection and sticking prevention or to treatment for the object of diffusion or antiglare.

The treatment with a hard coating is applied for the purpose of protecting the surface of the polarization plate from damage, and this hard coat film may be formed by a method in which, for example, a curable coated film with excellent hardness, slide property etc. is added on the surface of the transparent protective film using suitable ultraviolet curable type resins, such as acrylic type and silicone type resins. The antireflection treatment is applied for the purpose of antireflection of outdoor daylight on the surface of a polarization plate and it may be prepared by forming an antireflection film according to the conventional method etc. The sticking prevention treatment is applied for the purpose of adherence prevention with an adjoining layer of another member.

In addition, the antiglare treatment is applied in order to prevent a disadvantage that outdoor daylight reflects on the surface of a polarization plate to disturb visual recognition of transmitting light through the polarization plate, and the treatment may be applied, for example, by giving a fine rugged structure to the surface of the protective film using, for example, a suitable method, such as rough surfacing treatment method by sandblasting or embossing and a method of combining transparent fine particles. As the fine particles combined in order to form a fine rugged structure on the above-mentioned surface, transparent fine particles having an average particle size of 0.5 to 50 μm, for example, optionally electroconductive inorganic type fine particles comprising silica, alumina, titania, zirconia, tin oxide, indium oxide, cadmium oxide, antimony oxide, etc., and organic type fine particles (including beads) comprising crosslinked or non-crosslinked polymers may be used. When forming the fine rugged structure on the surface, the amount of fine particles used is usually about 2 to 50 weight parts, preferably 5 to 25 weight parts, relative to 100 weight parts of the transparent resin that forms the fine rugged structure on the surface. The antiglare layer may serve as a diffusion layer (viewing angle expanding function etc.) for diffusing transmitting light through the polarization plate and expanding a viewing angle etc.

In addition, the above-mentioned antireflection layer, sticking prevention layer, diffusion layer, antiglare layer, etc. may be built in the protective film itself, and also they may be prepared as an optical layer different from the transparent protective film.

The optical film may be used as an optical layer such as a reflective plate, a semi-transmissive plate, a retardation plate (including a half wavelength plate and a quarter wavelength plate), a viewing angle compensation film and a brightness enhancement film, which may be used for formation of a liquid crystal display etc. These are used in practice as an optical film or as one layer or two or more layers laminated on the polarizing plate.

Particularly preferable polarizing plates include a reflective polarization plate or a semi-transmissive polarization plate in which a reflective plate or a semi-transmissive reflective plate is further laminated on a polarizing plate; an elliptically polarizing plate or a circular polarizing plate in which a retardation plate is further laminated on the polarizing plate; a wide viewing angle polarization plate in which a viewing angle compensation film is further laminated on the polarizing plate; or a polarizing plate in which a brightness enhancement film is further laminated on the polarizing plate.

A reflective layer is arranged on a polarization plate to give a reflective polarization plate, and this type of plate is used for a liquid crystal display in which an incident light from a view side (display side) is reflected to give a display. This type of plate does not require built-in light sources such as a backlight, and has an advantage that a liquid crystal display may easily be made thinner. A reflective polarization plate may be formed using suitable methods, such as a method in which a reflective layer of metal etc. is, if required, attached to one side of a polarization plate via a transparent protective layer etc.

As an example of the reflective polarization plate, a plate may be mentioned on which, if required, a reflective layer is formed using a method of attaching a foil or vapor deposition film of reflective metal, such as aluminum, to one side of a matte treated transparent protective film. Moreover, a different type of plate with a fine rugged structure on the surface obtained by mixing fine particle into the above-mentioned transparent protective film, on which a reflective layer of rugged structure is prepared, may be mentioned. The reflective layer that has the above-mentioned fine rugged structure diffuses incident light by random reflection to prevent directivity and glaring appearance, and has an advantage of controlling unevenness of light and darkness etc. Moreover, the protective film containing the fine particle has an advantage that unevenness of light and darkness can be controlled more effectively by diffusion of an incident light and its reflected light upon transmission through the film. A reflective layer with fine rugged structure on the surface effected by a surface fine rugged structure of a protective film may be formed by a method of attaching a metal to the surface of a transparent protective layer directly using, for example, suitable methods such as a vacuum deposition method, an ion plating method, and a sputtering method and a plating method.

Instead of the method in which a reflection plate is directly given to the transparent protective film of the polarization plate, a reflection plate may also be used as a reflective sheet constituted by preparing a reflective layer on the suitable film for the transparent film. Since a reflective layer is usually made of metal, it is desirable that the reflective side is covered with a transparent protective film or a polarization plate etc. when used, from the viewpoint of preventing deterioration in reflectance by oxidation, of maintaining an initial reflectance for a long period of time and of avoiding preparation of a protective layer separately etc.

In addition, a semi-transmissive polarizing plate may be obtained by preparing the above-mentioned reflective layer as a semi-transmissive reflective layer, such as a half-mirror etc. that reflects and transmits light. A semi-transmissive polarization plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a semi-transmissive polarization plate. That is, the semi-transmissive polarization plate is useful to obtain a liquid crystal display of the type that saves energy of light sources, such as a back light, in a well-lighted atmosphere, and can be used with a built-in light source if needed in a comparatively dark atmosphere etc.

The above-mentioned elliptically polarization plate or circularly polarization plate on which the retardation plate is further laminated on the polarization plate is described in detail. These polarization plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used when changing the polarization direction of linearly polarized light.

The elliptically polarization plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarization plate in which three-dimensional refractive index is controlled may also preferably compensate (prevent) coloring produced when a screen of a liquid crystal display is viewed from an oblique direction. The circularly polarization plate is effectively used, for example, when adjusting a color tone of a picture of a reflective liquid crystal display that provides a colored picture, and it also has function of antireflection.

As retardation plates, birefringence films obtained by uniaxial or biaxial stretching polymer materials, oriented films of liquid crystal polymers, and materials in which orientated layers of liquid crystal polymers are supported with films may be mentioned. Although the thickness of the retardation plate is not particularly limited either, it is in general approximately from 20 to 150 μm.

Polymer materials include, for example, polyvinyl alcohols, polyvinyl butyrals, polymethyl vinyl ethers, polyhydroxyethyl acrylates, hydroxyethyl cellulose, hydroxypropyl cellulose, methyl cellulose, polycarbonates, polyarylates, polysulfones, polyethylene terephthalates, polyethylene naphthalates, polyethersulfones, polyphenylene sulfides, polyphenylene oxides, polyallyl sulfones, polyamides, polyimides, polyolefins, polyvinyl chlorides, cellulose type polymers, norbornene type resins, or bipolymers, terpolymers, graft copolymers, blended materials of the above-mentioned polymers. These polymer raw materials are formed into oriented materials (stretched film) using a stretching process and the like.

Liquid crystalline polymers include, for example, various kinds of polymers of principal chain type and side chain type in which conjugated linear atomic groups (mesogens) demonstrating liquid crystalline orientation are introduced into a principal chain and a side chain. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystalline polymers are obtained for example by spreading a solution of a liquid crystal polymer on an orientation treated surface where the surface of thin film such as polyimide and polyvinyl alcohol formed on a glass plate was subjected to rubbing treatment or where silicon oxide was deposited by an oblique evaporation method, and then heat-treating.

The retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarization plate or the above-mentioned reflected type elliptically polarization plate is a laminated plate combining suitably a polarization plate or a reflective polarization plate with a retardation plate. This type of elliptically polarization plate etc. may be manufactured by combining a polarization plate (reflected type) and a retardation plate, and by laminating them one by one separately in the manufacture process of a liquid crystal display. On the other hand, the polarization plate in which lamination was beforehand carried out and was obtained as an optical film, such as an elliptically polarization plate, is excellent in a stable quality, a workability in lamination etc., and has an advantage in improved manufacturing efficiency of a liquid crystal display.

The viewing angle compensation film is a film for extending viewing angle so that a picture may look comparatively clearly, even when it is viewed from an oblique direction not from vertical direction to a screen. Such viewing angle compensation retardation plate comprises, for example, a retardation plate, an orientation film of liquid crystalline polymer or the like, or an orientation layer of liquid crystalline polymer or the like supported on a transparent substrate. As a usual retardation plate, a polymer film having birefringence property that is uniaxially stretched in the plane direction is used, whereas as a retardation plate used as the viewing angle compensation film, a biaxially stretched film such as a polymer film having birefringence property that is biaxially stretched in the plane direction, an inclined orientation film or a polymer having birefringence property that is uniaxially stretched in the plane direction and also stretched in the depth direction to control the refractive index in the depth direction is used. As the inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The starting polymer for the retardation plate is the same polymer as described above in the retardation polymer and can be a suitable polymer for the purpose of preventing coloring caused by change of visible angle based on retardation by liquid crystal cell etc. and of expansion of viewing angle with good visibility.

Besides, an optical compensation retardation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarization plate with which a polarization plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarization plate, which is obtained by laminating a brightness enhancement film with a polarization plate, thus does not transmit light without the predetermined polarization state and reflects it, while obtaining transmitted light with the predetermined polarization state by accepting a light from light sources, such as a backlight. This polarization plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarization plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50% of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarization plate as it is, the absorption loss by the polarization plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarization plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarization plate may consist of multi-layered film of laminated layers of a polarization plate and two or more optical layers as the above-mentioned separated type polarization plate. Therefore, a polarization plate may be a reflective elliptically polarization plate or a semi-transmission type elliptically polarization plate, etc. in which the above-mentioned reflective polarization plate or a semi-transmissive polarization plate is combined with above described retardation plate respectively.

Although an optical film with the above described optical layer laminated on the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

Then, description will be given of a fabricating method for a pressure sensitive adhesion type optical film. No specific limitation is placed on a formation method for a pressure sensitive adhesive layer and the following methods can be used: one of which is a method in which a pressure sensitive adhesive solution is coated on the optical film and the film is dried and another of which is a method in which a pressure sensitive adhesive layer is transferred with a release sheet on which the pressure sensitive adhesive layer is formed. Coating methods that can be adopted are roll coating methods such as a reverse coating method and a gravure coating method, a spin coating method, a screen coating method, a fountain coating method, a dipping method, a spray method and the like. No specific limitation is placed on the thickness of a pressure sensitive adhesive layer, whereas the thickness thereof is preferably in the range of about 10 to 40 μm.

In a case where an anchor coat layer is provided, the anchor coat layer is formed on the optical film and thereafter, a pressure sensitive adhesive layer is formed. For example, an anchor component solution such as a polyethyleneimine aqueous solution is coated using a coating method such as a coating method, a dipping method, a spray method or the like and a coat is dried to form an anchor coat layer. The thickness of an anchor coat layer is preferably in the range of about 10 to 5,000 nm and more preferably in the range of about 50 to 500 nm. If the thickness of an anchor coat layer is excessively small, a case arises where no property thereof as a bulk is exerted, a strength is insufficient and adherence is insufficient. If the thickness thereof is excessively large, a possibility occurs that an optical characteristic is degraded.

In formation of a pressure sensitive adhesive layer, an activation treatment can be applied to an optical film. Various kinds of methods can be adopted in an activation treatment and, for example, a corona treatment, a low pressure UV treatment, a plasma treatment or the like can be adopted. Besides, an antistatic layer can be formed.

Examples of constituent materials of a release sheet include proper thin items such as paper; synthetic resin films made of polyethylene, polypropylene, polyethylene terephthalate; a rubber sheet, paper, cloth, unwoven fabric, net, a foam sheet and a metal foil, and a laminate thereof. In order to enhance releasability from a pressure sensitive adhesive layer 3, a release treatment imparting a low adherence, such as a silicone treatment, a long chain alkylation treatment or a fluorination treatment, may be applied onto the surface of a release sheet when required.

In addition, in the invention, ultraviolet absorbing property may be given to the above-mentioned each layer of the adhesive optical film of the invention, such as the optical film, and the adhesive layer etc., using a method of adding UV absorbents such as salicylic acid ester type compounds, benzophenol type compounds, benzotriazol type compounds, cyano acrylate type compounds, and nickel complex salt type compounds.

The pressure-sensitive adhesive optical film of the invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other components such as a lighting system and incorporating a driving circuit according to any conventional technique, except that the optical film of the invention is used. Any type of liquid crystal cell may also be used such as a TN type, an STN type and a π type.

Suitable liquid crystal displays, such as liquid crystal display with which the pressure sensitive adhesion type optical film has been located at one side or both sides of the liquid crystal cell, and with which a backlight or a reflective plate is used for a lighting system may be manufactured. In this case, the optical film by the invention may be installed in one side or both sides of the liquid crystal cell. When installing the optical films in both sides, they may be of the same type or of different type. Furthermore, in assembling a liquid crystal display, suitable parts, such as diffusion plate, antiglare layer, antireflection film, protective plate, prism array, lens array sheet, optical diffusion plate and backlight may be installed in suitable position in one layer or two or more layers.

Subsequently, organic electro luminescence equipment (organic EL display) will be explained. The optical film (polarizing plate etc.) of the invention can also be applied to organic EL display. Generally, in organic EL display, a transparent electrode, an organic luminescence layer and a metal electrode are laminated on a transparent substrate in an order configuring an illuminant (organic electro luminescence illuminant). Here, the organic luminescence layer is a laminated material of various organic thin films, and various compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by applying voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from the surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to λ/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to λ/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As a result, mirror surface of the metal electrode may be completely covered.

### EXAMPLES

While concrete description will be given of the invention using examples below, the invention is not limited to the examples. Note that the term “part or parts” and “%” should read “part or parts by weight” and “wt %”.

### (Fabrication of Polarizer)

A polyvinyl alcohol film with a thickness of 80 μm was stretched in a 0.3% iodine aqueous solution at a stretch ratio of 3 at 30° C. between rolls different in speed. Then, the polyvinyl alcohol film was stretched in an aqueous solution containing 4% boric acid and 10% potassium iodide at 60° C. to a total stretch ratio of 6. Then, the stretched film was immersed and washed in a 1.5% potassium iodide aqueous solution for 10 sec at 30° C., and dried for 4 min at 50° C. to thereby obtain a polarizer.

### (Fabrication of Polarizing Plate A)

Two saponified triacetyl cellulose films with a thickness of 80 μm were adhered onto respective both surfaces of the polarizer to thereby obtain a polarizing plate A.

### (Fabrication of Polarizing Plate B)

A film obtained by aligning a discotic liquid crystal (manufactured by Fuji Photo Film CO., Ltd. with a trade name of WV-SA128) was saponified and thereafter, the discotic liquid crystal was adhered onto one surface of the polarizer on one surface of a triacetyl cellulose film with a thickness of 80 μm so that the discotic liquid crystal was exposed to the outside. Onto the other surface of the polarizer, a saponified triacetyl cellulose film with a thickness of 80 μm was adhered, thereby fabricating a polarizing plate B.

### (Fabrication of Polarizing Plate C)

A polarizing plate C was fabricated in a similar way to that in the case of the polarizing plate B with the exception that in fabrication of the polarizing plate B, a norbornene-based film with a thickness of 80 μm (manufactured by JSR Corporation with a trade name of Arton) was used instead of WV-SA128.

### Example 1

### Preparation of Pressure Sensitive Adhesive

Into a reaction vessel with a cooling tube, a nitrogen introducing tube, a thermometer and an agitator, 100 parts of butyl acrylate and 0.3 part of 2,2′-azobisisobutylonitrile were added together with ethyl acetate, the mixture was subjected to a reaction at 60° C. in a nitrogen gas stream for 4 hr, thereafter ethyl acetate was added into the reaction liquid to obtain a solution (with a solid matter concentration of 30%) containing an acrylic polymer with a weight average molecular weight of 1,650,000. Mixed into the acrylic polymer solution were 0.2 part of dibenzoyl peroxide (manufactured by NOF Corporation. with a trade name of Nyper BO-Y), 0.07 part of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution to thereby obtain an acrylic pressure sensitive adhesive.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 155° C. for 3 min. The separator having the pressure sensitive adhesive layer formed thereon was transferred onto one surface of a polarizing plate A, to fabricate a pressure sensitive adhesion type polarizing plate.

### Example 2

### Preparation of Pressure Sensitive Adhesive

An acrylic pressure sensitive adhesive was obtained in a similar way to that in Example 1, with the exception that in Example 1, mixed were 0.2 part of dibenzoyl peroxide (manufactured by NOF Corporation. with a trade name of Nyper BO-Y), 0.15 part of trimethylolpropanexylenediisocyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto one surface of a polarizing plate A, to fabricate a pressure sensitive adhesion type polarizing plate.

### Example 3

### Preparation of Pressure Sensitive Adhesive

An acrylic pressure sensitive adhesive was obtained in a similar way to that in Example 1, with the exception that in Example 1, mixed were 0.2 part of dibenzoyl peroxide (manufactured by NOF Corporation. with a trade name of Nyper BO-Y), 0.6 part of trimethylolpropanetolylenediisocyanate and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto one surface of a polarizing plate A, to fabricate a pressure sensitive adhesion type polarizing plate.

### Example 4

### Preparation of Pressure Sensitive Adhesive

An acrylic pressure sensitive adhesive was obtained in a similar way to that in Example 1, with the exception that in Example 1, mixed were 0.15 part of dibenzoyl peroxide (manufactured by NOF Corporation. with a trade name of Nyper BO-Y), 0.07 part of trimethylolpropanexylenediisocyanate (TAKENATE D110N manufactured by Mitsui Takeda Chemicals Inc.) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 155° C. for 3 min. The separator having the pressure sensitive adhesive layer formed thereon was transferred onto a polarizing plate A, to fabricate a pressure sensitive adhesion type polarizing plate.

### Example 5

### Preparation of Pressure Sensitive Adhesive

An acrylic pressure sensitive adhesive was obtained in a similar way to that in Example 1, with the exception that in Example 1, mixed were 0.3 part of dibenzoyl peroxide (manufactured by NOF Corporation. with a trade name of Nyper BO-Y), 0.07 part of trimethylolpropanexylenediisocyanate (TAKENATE D110N manufactured by Mitsui Takeda Chemicals Inc.) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution. (Fabrication of Pressure Sensitive Adhesion Type Optical Film)

A pressure sensitive adhesive layer with a thickness of 20 μm was obtained by coating the pressure sensitive adhesive on a separator constituted of a polyester film surface treated with a silicone-based release agent to heat a coat at 155° C. for 3 min. The separator having the pressure sensitive adhesive layer formed thereon was transferred onto a polarizing plate A, to fabricate a pressure sensitive adhesion type polarizing plate.

### Example 6

### Preparation of Pressure Sensitive Adhesive

Into a reaction vessel with a cooling tube, a nitrogen introducing tube, a thermometer and an agitator, 100 parts of ethyl acrylate and 0.3 part of 2,2′-azobisisobutylonitrile were added together with ethyl acetate, the mixture was subjected to a reaction at 60° C. in a nitrogen gas stream for 4 hr, thereafter ethyl acetate was added into the reaction liquid to obtain a solution (with a solid matter concentration of 30%) containing an acrylic polymer with a weight average molecular weight of 1,800,000. Mixed into the acrylic polymer solution were 0.2 part of dibenzoyl peroxide (manufactured by NOF Corporation. with a trade name of Nyper BO-Y), 0.07 part of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution to thereby obtain an acrylic pressure sensitive adhesive.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 155° C. for 3 min. The separator having the pressure sensitive adhesive layer formed thereon was transferred onto one surface of a polarizing plate A, to fabricate a pressure sensitive adhesion type polarizing plate.

### Example 7

### Fabrication of Pressure Sensitive Adhesion Type Optical Film

A pressure sensitive adhesion type polarizing plate was fabricated in a similar way to that in Example 1 with the exception that in Example 1, a polarizing plate B was used instead of polarizing plate A, and a separator having a pressure sensitive adhesive layer formed thereon was adhered to the surface of the polarizing plate on which a discotic liquid crystal was aligned.

### Example 8

### Fabrication of Pressure Sensitive Adhesion Type Optical Film

A pressure sensitive adhesion type polarizing plate was fabricated in a similar way to that in Example 1 with the exception that in Example 1, a polarizing plate C was used instead of polarizing plate A, and a separator having a pressure sensitive adhesive layer formed thereon was adhered to a norbornene-based film surface of the polarizing plate.

### Comparative Example 1

### Preparation of Pressure Sensitive Adhesive

An acrylic pressure sensitive adhesive was obtained in a similar way to that in Example 1, with the exception that in Example 1, mixed were 0.2 part of dibenzoyl peroxide (manufactured by NOF Corporation. with a trade name of Nyper BO-Y), 0.005 part of trimethylolpropanexylenediisocyanate (TAKENATE D110N manufactured by Mitsui Takeda Chemicals Inc.) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

### Comparative Example 2

### Preparation of Pressure Sensitive Adhesive

An acrylic pressure sensitive adhesive was obtained in a similar way to that in Example 1, with the exception that in Example 1, mixed were 0.2 part of dibenzoyl peroxide (manufactured by NOF Corporation. with a trade name of Nyper BO-Y) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

### Comparative Example 3

### Preparation of Pressure Sensitive Adhesive

Into a reaction vessel with a cooling tube, a nitrogen introducing tube, a thermometer and an agitator, 99 parts of butyl acrylate, 1.0 part of 2-hydroxyethyl acrylate and 0.3 part of 2,2′-azobisisobutylonitrile were added together with ethyl acetate, the mixture was subjected to a reaction at 60° C. in a nitrogen gas stream for 4 hr, thereafter ethyl acetate was added into the reaction liquid to obtain a solution (with a solid matter concentration of 30%) containing an acrylic polymer with a weight average molecular weight of 1,670,000. Mixed into the acrylic polymer solution were 0.07 part of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution to thereby obtain an acrylic pressure sensitive adhesive.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

### Comparative Example 4

### Preparation of Pressure Sensitive Adhesive

An acrylic pressure sensitive adhesive was obtained in a similar way to that in Example 1, with the exception that in Example 1, mixed were 0.2 part of dibenzoyl peroxide (manufactured by NOF Corporation. with a trade name of Nyper BO-Y), 6.0 parts of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

### Comparative Example 5

### Preparation of Pressure Sensitive Adhesive

An acrylic pressure sensitive adhesive was obtained in a similar way to that in Example 1, with the exception that in Example 1, mixed were 0.01 part of dibenzoyl peroxide (manufactured by NOF Corporation. with a trade name of Nyper BO-Y), 0.07 part of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

### Comparative Example 6

### Preparation of Pressure Sensitive Adhesive

An acrylic pressure sensitive adhesive was obtained in a similar way to that in Example 1, with the exception that in Example 1, mixed were 3.0 parts of dibenzoyl peroxide (manufactured by NOF Corporation. with a trade name of Nyper BO-Y), 0.07 part of trimethylolpropanexylenediioscyanate (manufactured by Mitsui Takeda Chemicals Inc. with a trade name Takenate D110N) and 0.2 part of a silane coupling agent (manufactured by Soken Chemical & Engineering Co., Ltd. with a trade name of A-100, which is an acetoacetyl group-containing silane coupling agent) relative to 100 parts of a solid matter of the acrylic polymer solution.

### (Fabrication of Pressure Sensitive Adhesion Type Optical Film)

A pressure sensitive adhesive layer with a thickness of 20 μm was obtained by coating the pressure sensitive adhesive on a separator constituted of a polyester film surface-treated with a silicone-based release agent to heat a coat at 150° C. for 5 min. The separator having the pressure sensitive adhesive layer formed thereon was transferred onto a polarizing plate A, to fabricate a pressure sensitive adhesion type polarizing plate.

The pressure sensitive adhesion type optical films obtained in the Examples and the Comparative Examples were evaluated as follows. The evaluation results are shown in Table 1.

### <Warping>

The pressure sensitive adhesion type polarizing plates (360 mm in length×360 mm in width) obtained in the Examples and Comparative Examples were adhered on one surface of a non-alkali glass plate with a thickness of 0.07 mm. Then, the composites were treated in an autoclave at 50° C. under 5 atm for 15 min so as to realize a perfect adherence. The samples each were subjected to a first treatment in conditions of 80° C. and 48 hr, and a second treatment in conditions of 60° C., 90% RH and 48 hr, thereafter, placed on a horizontal table without depressions or protrusions in an atmosphere at 23° C. and 55% RH and a warping was measured on each sample at 4 points on the surface thereof with a clearance gauge. Warpings obtained at the 4 points were averaged to obtain a representative which is also referred to a warping. Evaluation criteria are as follows:

◯: a warping of a glass plate is less than 0.5 mm.
Δ: a warping of a glass plate is in the range of from 0.5 to 1.0 mm.
x: a warping of a glass plate exceeds 1.0 mm.

### <Light Leakiness>

The pressure sensitive adhesion type polarizing plates (420 mm in length and 320 mm in width) obtained in the Examples and Comparative Examples were adhered on both surfaces of each non-alkali glass plate with a thickness of 0.07 mm so as to be in the cross-Nichols relation. Then, the composites were treated in an autoclave at 50° C. under 5 atm for 15 min so as to realize a perfect adherence. After the samples were treated in conditions of 90% RH and 100° C. and 60° C. respectively for 48 hr, the samples were placed on a backlight with 10,000 cd and light leakiness was visually observed with evaluation criteria below described.

◯: no problem in practical use
Δ: at a level of almost no problem in practical use, but slightly insufficient under visual observation
x: problematic in practical use

### <Durability>

The pressure sensitive adhesion type polarizing plates (420 mm in length and 320 mm in width) obtained in the Examples and Comparative Examples were adhered on both surfaces of each non-alkali glass plate with a thickness of 0.07 mm so as to be in the cross-Nichols relation. Then, the composites were treated in an autoclave at 50° C. under 5 atm for 15 min so as to realize a perfect adherence. After the samples were treated in conditions of 90% RH and 100° C. and 60° C. respectively for 500 hr, the samples were visually observed as to foaming, peeling off and film lifting with evaluation criteria described below.

◯: there is no foaming, peeling off or film lifting.
Δ: at a level of almost no problem in practical use, but slightly insufficient under visual observation
x: problematic in practical use

### <Adherence>

The pressure sensitive adhesion type polarizing plates obtained in the Examples and Comparative Examples were cut into pieces of 25 mm in width which were then stuck on an ITO film by rolling once back and forth with a 2-kg roller. The samples thus obtained were used to measure the peel adhesion force between the optical film and the ITO film at a peel angle of 90° C. at a peel rate of 300 mm/min. in an atmosphere at 23° C., 55% RH.

### <Adhesive Deficiency>

The pressure sensitive adhesion type polarizing plates obtained in the Examples and Comparative Examples were punched in to squares with a side of 270 mm in length with one square sample from each polarizing plate and adhesive deficiency at an edge was evaluated with evaluation criteria described below:

◯: a depth of adhesive deficiency from an edge is less than 100 μm
Δ: a depth of adhesive deficiency from an edge is in the range of from 100 to less than 300 μm
x: a depth of adhesive deficiency from an edge is equal to or more than 300 μm

### <Punching Property>

The pressure sensitive adhesion type polarizing plates obtained in the Examples and Comparative Examples were punched in to squares with a side of 270 mm in length with 100 pieces from each polarizing plate, a worker observed on the pieces with an naked eye and touch feeling to confirm the presence or absence of pressure sensitive adhesion feeling on side faces of the polarizing plates. Besides, in a case where a surface of a polarizing plate was contaminated, the state was determined to be adhesive contamination. Evaluation criteria were as follows:

◯: none of 100 pieces observed is determined to be adhesive contamination.
Δ: 1 to 5 of 100 pieces observed are determined to be adhesive contamination.
x: 6 or more of 100 pieces observed are determined to be adhesive contamination.

TABLE 1

| | | Examples | | | | | | | |
|---|---|---|---|---|---|---|---|---|---|
| | | 1 | 2 | 3 | 4 | 5 | 6 | 7 | 8 |
| Presence or absence of hydroxyl | | absent | absent | absent | absent | absent | absent | absent | absent |
| group in polymer (A) | | | | | | | | | |
| Amount of peroxide (B) used | | 0.2 | 0.2 | 0.2 | 0.15 | 0.3 | 0.2 | 0.2 | 0.2 |
| Amount of isocyanate-based | | 0.07 | 0.15 | 0.6 | 0.07 | 0.07 | 0.07 | 0.07 | 0.07 |
| crosslinking agent (C) used | | | | | | | | | |
| Type of polarizing plate | | A | A | A | A | A | A | B | C |
| Warping | 80° C. × 48 hours | ∘ | ∘ | ∘ | ∘ | ∘ | ∘ | ∘ | ∘ |
| | 60° C., 90% RH × 48 hours | ∘ | ∘ | ∘ | ∘ | ∘ | ∘ | ∘ | ∘ |
| Light | 100° C. × 48 hours | ∘ | ∘ | ∘ | ∘ | ∘ | ∘ | ∘ | ∘ |
| leakiness | 60° C., 90% RH × 48 hours | ∘ | ∘ | ∘ | ∘ | ∘ | ∘ | ∘ | ∘ |
| Durability | 100° C. × 500 hours | ∘ | ∘ | ∘ | ∘ | ∘ | ∘ | ∘ | ∘ |
| | 60° C., 90% RH × 500 hours | ∘ | ∘ | ∘ | ∘ | ∘ | ∘ | ∘ | ∘ |
| Adherence (N/25 mm) | | 20 | 32 | 21 | 20 | 20 | 19 | 18 | 20 |
| Adhesive deficiency | | ∘ | ∘ | ∘ | ∘ | ∘ | ∘ | ∘ | ∘ |
| Punching | pressure sensitive adhesion | ∘ | ∘ | ∘ | ∘ | ∘ | ∘ | ∘ | ∘ |
| property | feeling on sides | | | | | | | | |
| | adhesive contamination | ∘ | ∘ | ∘ | ∘ | ∘ | ∘ | ∘ | ∘ |

Comparative Examples

| | | | | | |
|---|---|---|---|---|---|
| 1 | 2 | 3 | 4 | 5 | 6 |

| Presence or absence of hydroxyl | | absent | absent | present | absent | absent | absent |
|---|---|---|---|---|---|---|---|
| group in polymer (A) | | | | | | | |
| Amount of peroxide (B) used | | 0.2 | 0.2 | — | 0.2 | 0.01 | 3 |
| Amount of isocyanate-based | | 0.005 | — | 0.07 | 6 | 0.07 | 0.07 |
| crosslinking agent (C) used | | | | | | | |
| Type of polarizing plate | | A | A | A | A | A | A |
| Warping | 80° C. × 48 hours | ∘ | ∘ | ∘ | x | ∘ | x |
| | 60° C., 90% RH × 48 hours | ∘ | ∘ | ∘ | x | ∘ | x |
| Light | 100° C. × 48 hours | ∘ | ∘ | ∘ | x | ∘ | x |
| leakiness | 60° C., 90% RH × 48 hours | ∘ | ∘ | ∘ | x | ∘ | x |
| Durability | 100° C. × 500 hours | ∘ | ∘ | ∘ | ∘ | x | ∘ |
| | 60° C., 90% RH × 500 hours | ∘ | ∘ | ∘ | ∘ | x | ∘ |
| Adherence (N/25 mm) | | 9 | 5 | 18 | 45 | 20 | 20 |
| Adhesive deficiency | | Δ | x | ∘ | ∘ | ∘ | ∘ |
| Punching | pressure sensitive adhesion | x | x | x | ∘ | x | ∘ |
| property | feeling on sides | | | | | | |
| | adhesive contamination | x | x | x | ∘ | x | ∘ |

1. A pressure-sensitive adhesive for an optical film, comprising 0.02 to 2 parts by weight of a peroxide (B) and 0.01 to 5 parts by weight of an isocyanate-based compound (C) contained in 100 parts by weight of a (meth)acrylic polymer (A) consisting primarily of an alkyl(meth)acrylate and not containing a functional group reactive with an isocyanate group.

2. A pressure-sensitive adhesive layer for an optical film, which is obtained by crosslinking reaction of the pressure-sensitive adhesive for an optical film of claim 1.

3. A method for manufacturing a pressure-sensitive adhesive layer for an optical film, which comprises crosslinking reaction of the pressure-sensitive adhesive for an optical film of claim 1 to form a pressure-sensitive adhesive layer.

4. A pressure sensitive adhesion type optical film comprising the pressure sensitive adhesive layer for an optical film of claim 2 laminated on at least one surface of an optical film.

5. The pressure sensitive adhesion type optical film according to claim 4, wherein the adherence between the optical film and the pressure sensitive adhesive layer is 10 N/25 mm or more in a 90° C. peel test.

6. An image display using at least one sheet of the pressure sensitive adhesion type optical film of claim 4 or 5.
